(19) United States
(12) Patent Application Publication
(10) Pub. No.: US 2014/0356821 A1
(43) Pub. Date: Dec. 4, 2014

(54) VOCABULARY LEARNING TOOLS

(71) Applicant: VO-CAB IT, LLC, Denver, CO (US)

(72) Inventors: Kevin Krom, Denver, CO (US); Tyler Sapkin, Denver, CO (US); Anthony Zurcher, Denver, CO (US)

(21) Appl. No.: 14/198,206

(22) Filed: Mar. 5, 2014

Related U.S. Application Data
(60) Provisional application No. 61/774,487, filed on Mar. 7, 2013.

(51) Int. Cl. G09B 5/02; G09B 19/04

(52) U.S. Cl. CPC G09B 5/02; G09B 19/04
USPC 434/176

(57) ABSTRACT

A facility for vocabulary learning is described.

### CROSS REFERENCE TO RELATED APPLICATION

This application claims the benefit of U.S. Provisional Application No. 61/774,487, filed Mar. 7, 2013, the entirety of which application is incorporated by reference herein.

### TECHNICAL FIELD

The described technology is directed to the field of automated learning tools.

### BACKGROUND

The World Wide Web (“the Web”) is a system for publishing information, in which the users may use a web browser application to retrieve information, such as web pages, online texts, online books, etc.

It is common for a user to acquire definitions of words included online texts by typing the word into online dictionaries such as dictionary.com, which display a number of definitions, synonyms, examples, and pronunciations to be reviewed by the user. For example, websites managed by some dictionary companies include a webpage for each word offered. It is typical for such web pages to include the history, origin, nearby words, and cultural definition.

In other cases, on some tablet readers it is possible for a user to highlight a word and, at the bottom of the page, a see [display] condensed definition. In some cases, this definition is accompanied by the word's pronunciation, and the option to look up the full definition on the internet.

### BRIEF DESCRIPTION OF THE DRAWINGS

FIG. 1 shows a display presented by the facility in order to register a new user for the community.

FIG. 2 shows a display presented by the facility to a member of the community containing the users homepage.

FIG. 3 shows a display presented by the facility when the “quiz” link to create a vocabulary quiz is selected by the user.

FIG. 4 shows a display presented by the facility when the user selects, “tap here for definition” and searches the Internet for a visual aid.

FIG. 5 shows a display presented by the facility after the user has created a flash card with a visual aid.

FIG. 6 shows a display presented by the facility after the user has created a flash card presenting the material in a new format including the visual aid.

FIG. 6A shows a display presented by the facility demonstrating how the card changes with “tap here for definition” is selected.

FIG. 6B shows a display presented by the facility showing the definition, synonym, antonym, and example in the multiple-choice format.

FIG. 7 shows a display presented by the facility in order to set up parental, teacher, or guardian controls.

FIG. 8 shows a display presented by the facility when the user is working within an Ebook reader application, (Ibook, Kindle) on the controls of how to enter vocabulary words into the facility.

FIG. 9 is a network diagram of a sample arrangement of components used to provide a facility in some embodiments.

FIG. 10 is a block diagram showing some of the components typically incorporated in at least some of the computer systems and other devices on which the facility executes.

FIG. 11 shows a display presented by the facility as an alternative view for quizzing vocabulary words.

### DETAILED DESCRIPTION

Problems identified by Inventory with Conventional Approach:

Limited exposure: This approach to displaying vocabulary words in the conventional layouts has significant disadvantages. One problem with the conventional approach is that it gives the user one exposure to the unknown vocabulary word. It is possible that the user may need multiple exposures to the definition in order to fully comprehend the word.

Learning styles: A second problem with the conventional approach is that it assumes that all people learn in a uniform manner. The conventional process provides definition in written form, and an example pronunciation of the word. It is not the case that all learning styles are represented in the conventional process for memorizing vocabulary words.

Choice & Connection: A third problem with the conventional approach to memorizing vocabulary is the lack of integration of words into the users everyday life. Moreover, the student rarely has the ability to choose the words or the field of words that he wants to study and put to memory.

### Parental Controls:

Another problem with the conventional approach to studying vocabulary is the parents have little insight into how diligent their child is studying. The parents are unable to track the vocabulary progress of their child. While it is the schools obligation to ensure all students learn at about the same pace, some students might develop later or differently than other students.

Incentive: A fifth problem is there is little incentive to continually acquire advanced vocabulary words. Beyond raising scores for the GMAT, MCAT, LSAT, SAT, ACT or other graduate evaluate level exams, maintaining and advancing ones vocabulary is not a priority nor is it particularly valuable for most people.

In view of these disadvantages, a more effective approach to memorizing and building ones vocabulary would have substantial utility.

How vo-CAB it Solves Conventional Problems:

### 1. Limited Exposure:

1. Very few individuals commit something to memory with only one exposure.

2. Having a vocabulary list in electronic form gives you unlimited potential to study (at the bus stop, on the way to class, etc)

3. Can't lose your word list.

4. Have the ability to keep track of vocabulary words long after you take the test.

5. Repetition over years

6. Track users progress in vocabulary acquisition.

A software and/or hardware facility (“the facility”) that saves vocabulary words from online texts and puts them into flash card format, gives the users repeated exposure to the definition. In some embodiments, the facility allows the user to study vocabulary without having to carry his homework with him. In some embodiments, the facility saves vocabulary words in an online database to avoid losing note cards and ensure continuous exposures to the users chosen vocabulary words. In some embodiments, the facility continually quizzes users on past vocabulary words to ensure long term memorization as opposed cramming for a test and forgetting the definition soon there after. In some embodiments, the facility ranks the level of difficulty of the vocabulary words and allow the user to gauge his progress in vocabulary mastery. In some embodiments, the facility connects and shares the users vocabulary level on social media platforms such as facebook, to encourage friendly competition.

### 2. Learning Styles:

In some embodiments, the facility provides the user with multiple formats for putting vocabulary words to memory. In some embodiments, the facility provides visual learners the option to run an Internet image search to pair with their definition. In some embodiments, the facility provides the user with spoken definition, example, and synonym to help memorization for auditory learners. In some embodiments, the facility provides the user with an object to hold or play, or a separate screen to manipulate with his fingers with in order to help Kinesthetic learners. The facility offers multiple methods of acquiring vocabulary to fit the needs of all learners.

### 3. Choice & Connection:

1. Up in till this application, the process of acquiring vocabulary and reading were quite separate. The facility bridges the gap between reading and memorization.

2. Giving the user the option to choose his own vocabulary words puts the power in his hands.

3. The user should not feel compelled to only “CAB” (meaning to select and transpose a vocabulary word in the application) academic and more advanced vocabulary, but also words that the user finds interesting.

The facility connects the act of reading to the acquisition and memorization of vocabulary words. In some embodiments, the facility gives the user the opportunity to choose what vocabulary words he or she deems interesting. Moreover, building off the users interests encourages further learning in whatever field that captivates them.

### Parental Controls:

Another problem with the conventional approach to studying vocabulary is the parents and or teachers have little control over how diligent their child is studying, or what words they are studying. To ensure optimal results, in some embodiments, the facility locks specific applications if the user is not performing to the parent's or teacher's expectations. For example, the parents can set up requirements of at least 80% on their quizzes in order to access specific applications. In order to regulate the users progress, the facility provides a “master” quiz, which is to be administrated by the users parent, or guardian, which allows the user to test out of specific vocabulary lists. In some embodiments, the facility requires at least 20 new words a week. The Facility would present the users parents or guardians with access to the users vocabulary words.

4. Incentivize the Learning Process:

1. Reward with deals for other applications

2. Encourage the pursuit of continuous learning. (Renaissance individual)

In order to offset the tension from the parental controls, in some embodiments, the facility provides the users with financial rewards to the tune of credits towards other applications. In some embodiments, the facility provides a reward for every 100 words memorized by the user.

### DETAILED DESCRIPTION

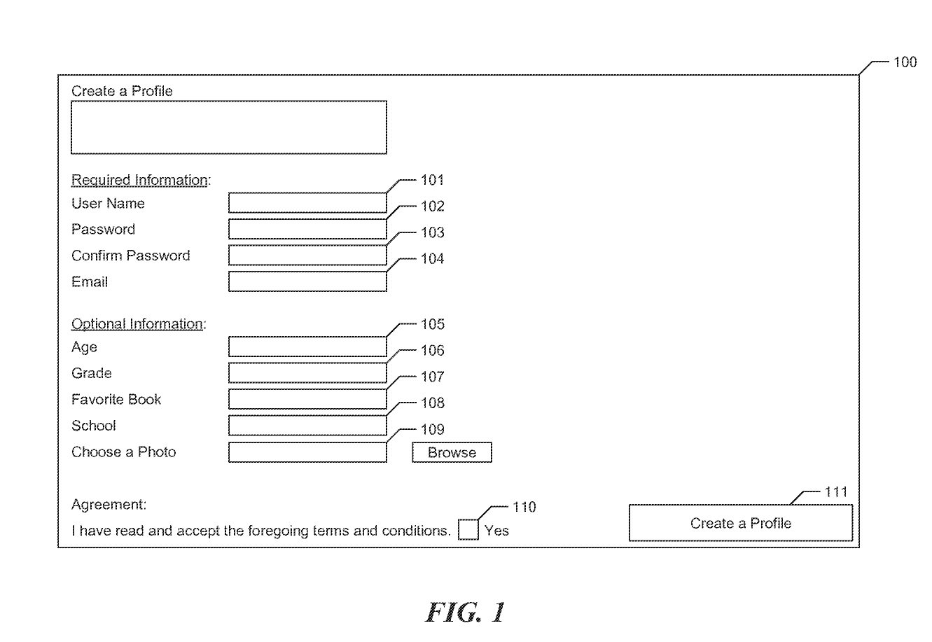

FIG. 1 shows a display presented by the facility in order to register a new user for the community. The display 100 includes user interface controls for entering information such as the following: a user name 101 used to identify the user: a password 102 used by the user to authenticate his or her identity to the facility: An email address 103 at which the user can receive email directed to the user: an indication as to the users age 104: An indication as to the users grade 105: An indication as to the users favorite book 106: An indication as to the users current school 107: a photo 108 portraying the user: and an indication that the user has read agreements relating to the user of the facility. After entering this information, the user selects control 109 in order to create a profile. Some embodiments of the facility allow the user to connect their profile to social networking sites such as Facebook, Twitter, and Linkedln.

In response, the facility generates a confirmation code and transmits it to the user's email, such as in the form of an email. When the user receives the conformation code in their email, the user enters it into a subsequent display generated by the facility (not shown) to complete the creation of the user's profile.

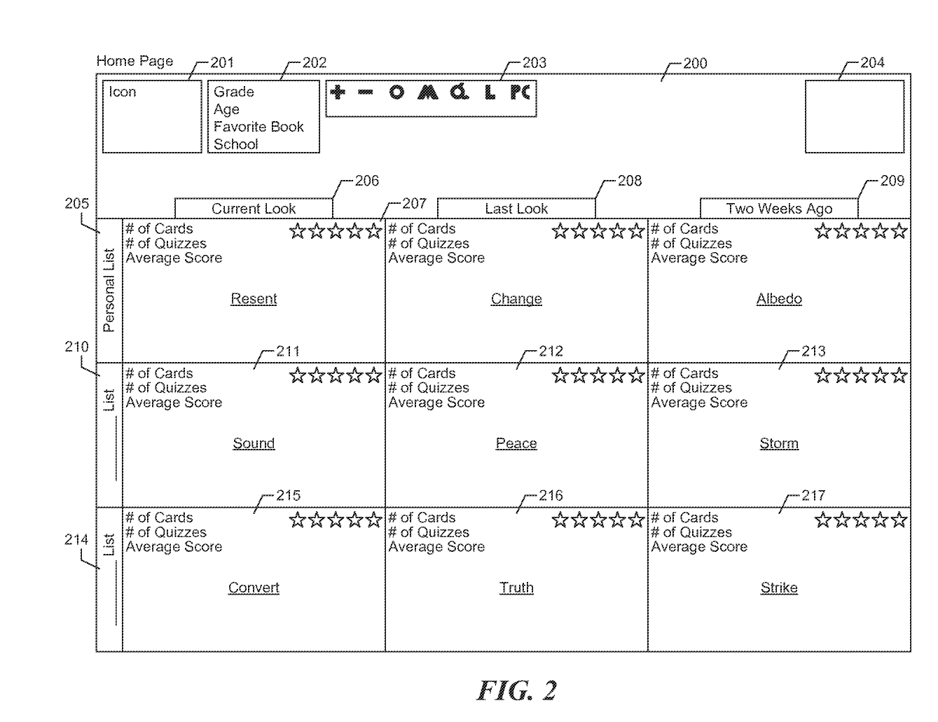

FIG. 2 shows a display presented by the facility to a member of the community containing the users homepage. The homepage 200 has selections listing new, old, downloaded, and troublesome vocabulary lists, and words. 201 presents the icon or image that the user has selected while creating their profile: The optional information entered in 202 displays the users grade, age, favorite book, and school: The homepage also contains 203 controls for adding, deleting, editing, master quizzing, user administered quiz's, the ability to log out of the vocabulary lists presented on the homepage, and parental controls. The facility also provides 204 which lists vocabulary words added for the present week, total words added, and current vocabulary rank. The homepage also contains 205, 206, and 207 which represent the user generated and most current vocabulary list: 208 displays last weeks user generated vocabulary list: 209 shows the user generated vocabulary list from two weeks prior to the current date: 210, and 211 displays the most current vocabulary list downloaded from an internet browser: 212, and 213 display downloaded vocabulary lists from one week prior to two weeks prior to the current date: 214 displays a vocabulary list entered by the facility for words that the user has consistently gotten incorrect: 215 represents the most current “troubling” vocabulary list, 216 represents last weeks troubling words, 217 displays two weeks prior to the date's troubling words.

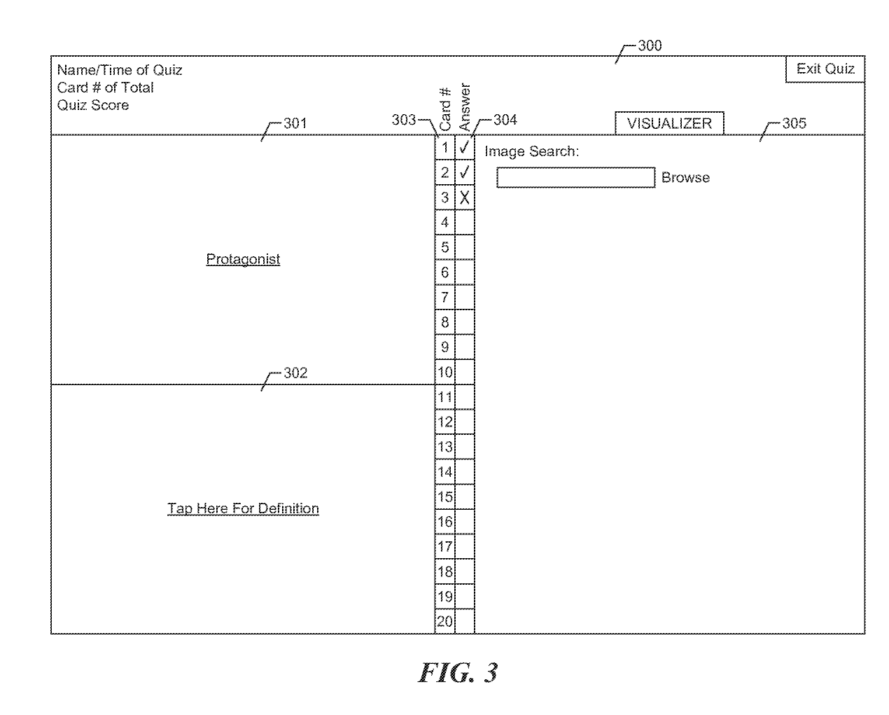

FIG. 3 shows a display presented by the facility when the “quiz” link to create a vocabulary quiz is selected by the user. This display 300 contains information pertaining to the name/date of quiz, card # of total cards, and current quiz score along with controls to exit the quiz: The display 301 represents the vocabulary word in question, 302 displays a blank flash card which needs to be touched to present the definition: the display 303 provides the user with what number of flash card he is currently on in relation to the number of total cards: The display 304 presents the user with which cards he answered correctly verses incorrectly. The display 305 presents the user with the option to combine an Internet based image search with the vocabulary word in question.

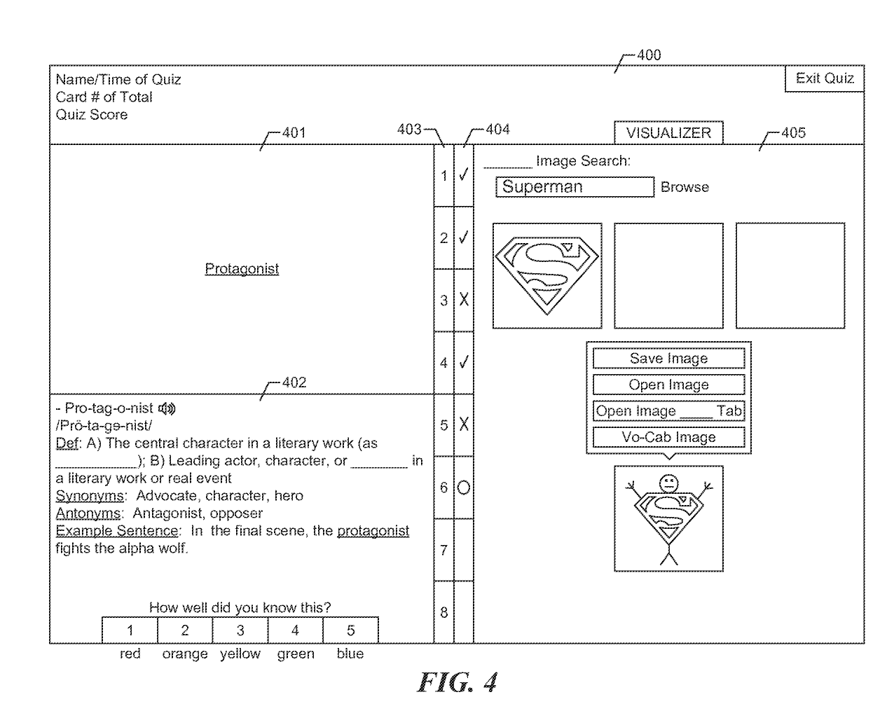

FIG. 4 shows a display presented by the facility when the user selects, “tap here for definition” and searches the Internet for a visual aid. The display 400 contains information pertaining to the name/date of quiz, card # of total cards, quiz number, and provides controls for exiting the quiz. The display 401 presents the user with the vocabulary word selected from their online text: Display 402 presents the user with the definition, pronunciation, synonyms, antonyms, example, and a color coded bar at the bottom to gauge the users familiarity with the vocabulary word in question: The display 403 presents the user with what card number they are currently on in relationship to the rest of the quiz: The display 404 presents the user with the results of their quiz thus far: The display 405 illustrates how the user selects an image from an internet image search and places it within the facility.

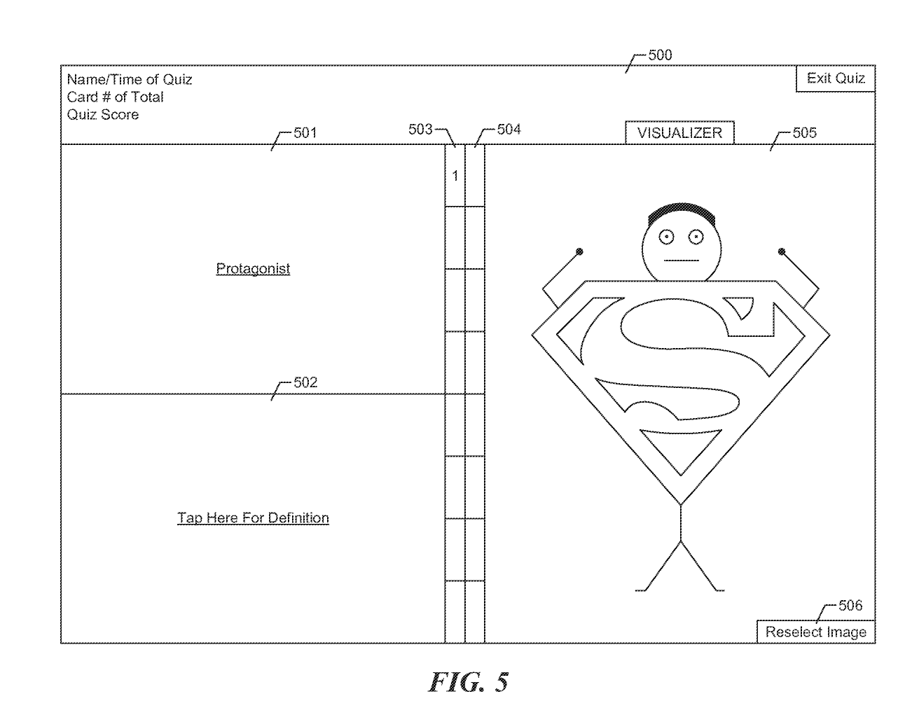

FIG. 5 shows a display presented by the facility after the user has created a flash card with a visual aid. The display 500 contains controls for quizzing the user on the definition of a vocabulary word of their choosing: The display 501 presents the user with the vocabulary word which was selected from an online text: The display 502 presents the user with blank flash card: The display 503 presents the user with the number of flash cards they have completed within the quiz: The display 504 presents the user with the out come of their answers to the previous flash cards in the quiz: The display 505 presents the user with the icon selected by the user to accompany their vocabulary word.

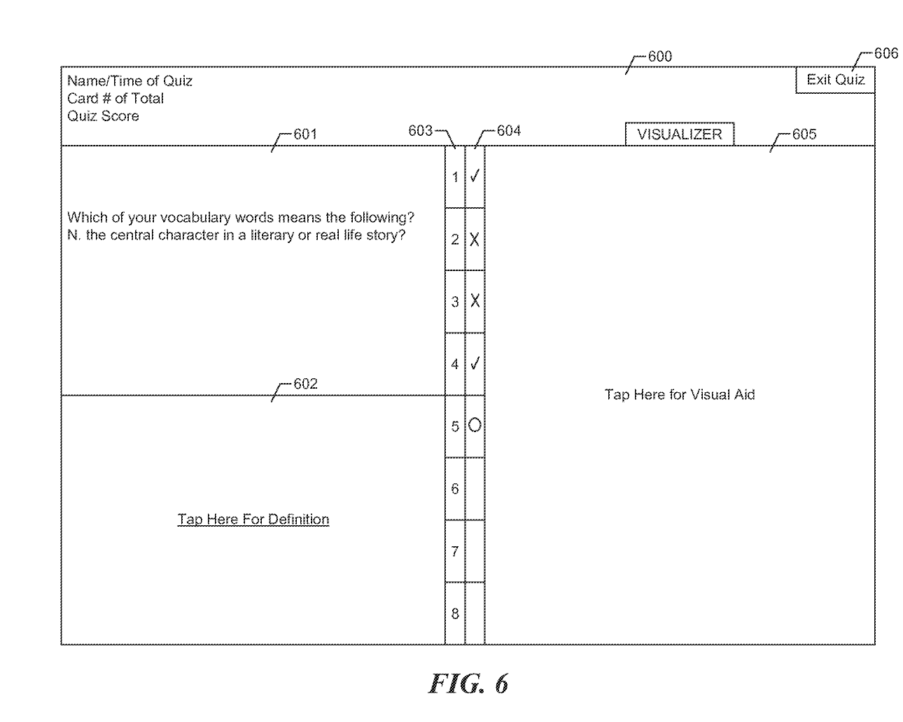

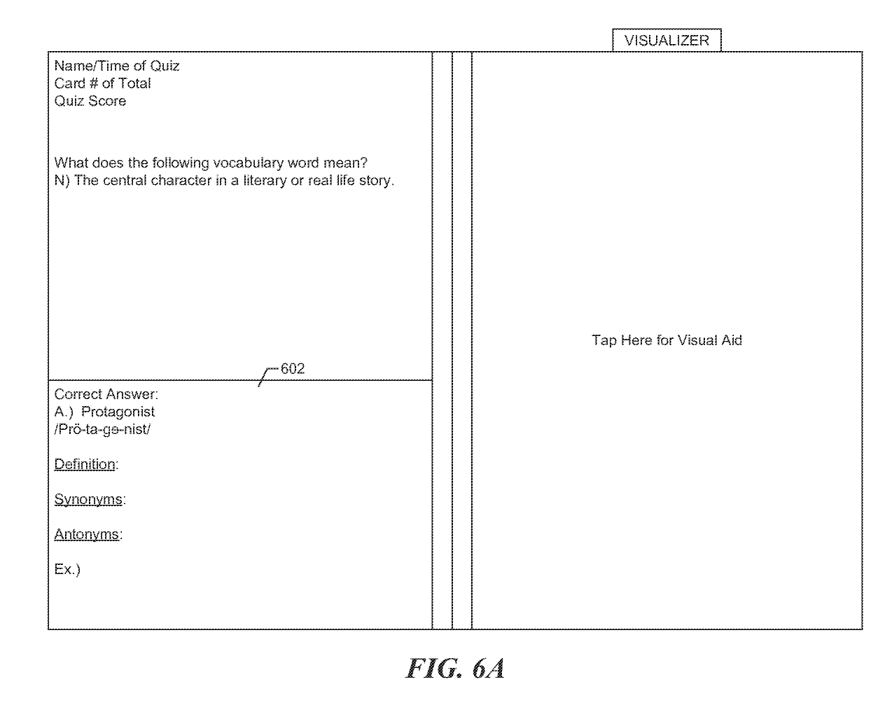

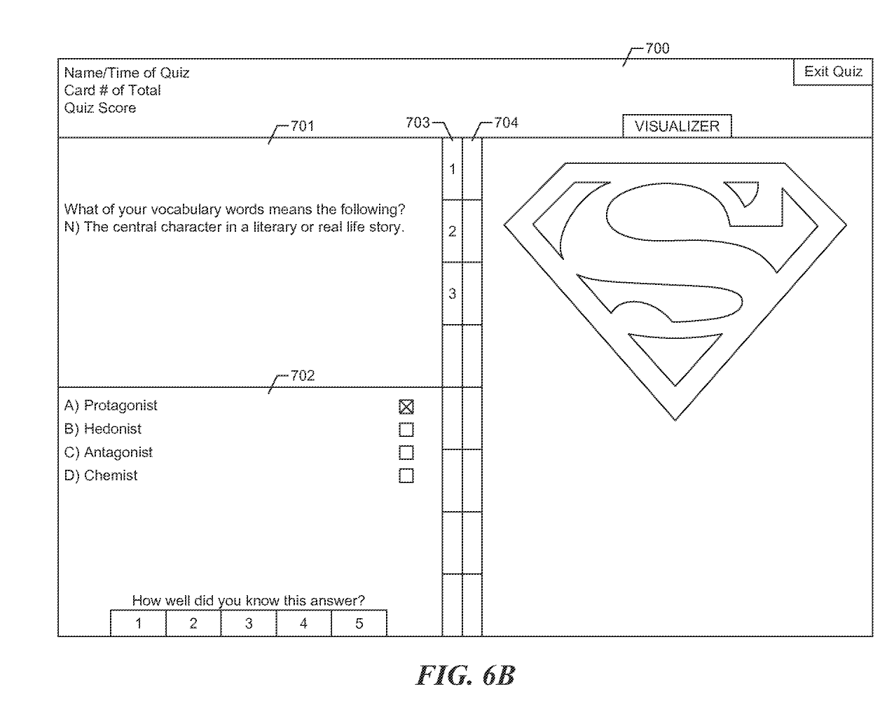

FIG. 6 shows a display presented by the facility after the user has created a flash card presenting the material in a new format including the visual aid.

FIG. 6A shows a display presented by the facility demonstrating how the card changes with “tap here for definition” is selected.

FIG. 6B shows a display presented by the facility showing the definition, synonym, antonym, and example in the multiple-choice format.

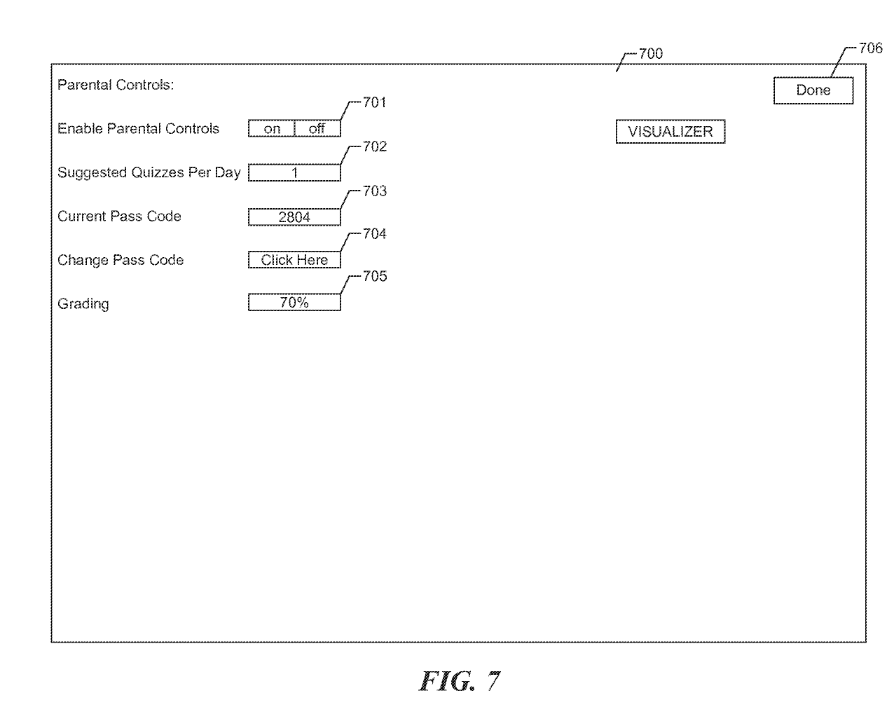

FIG. 7 Shows a display presented by the facility in order to set up parental, teacher, or guardian controls. The display 701 presents the users parent or guardian the option to set reminders for user generated quizzes. The display 702 presents the users parent or guardian to set the number of reminders for quizzes that the user will see per day. The display 703 presents the users parent or guardian with their current passcode to set or change parental controls. The display 704 presents the users parent or guardian the option to change the passcode incase the user obtains the passcode. The display 705 presents the users of the parents or guardians the option to establish a minimum score to access other applications. The display 706 presents the user with the ability to return to the homepage.

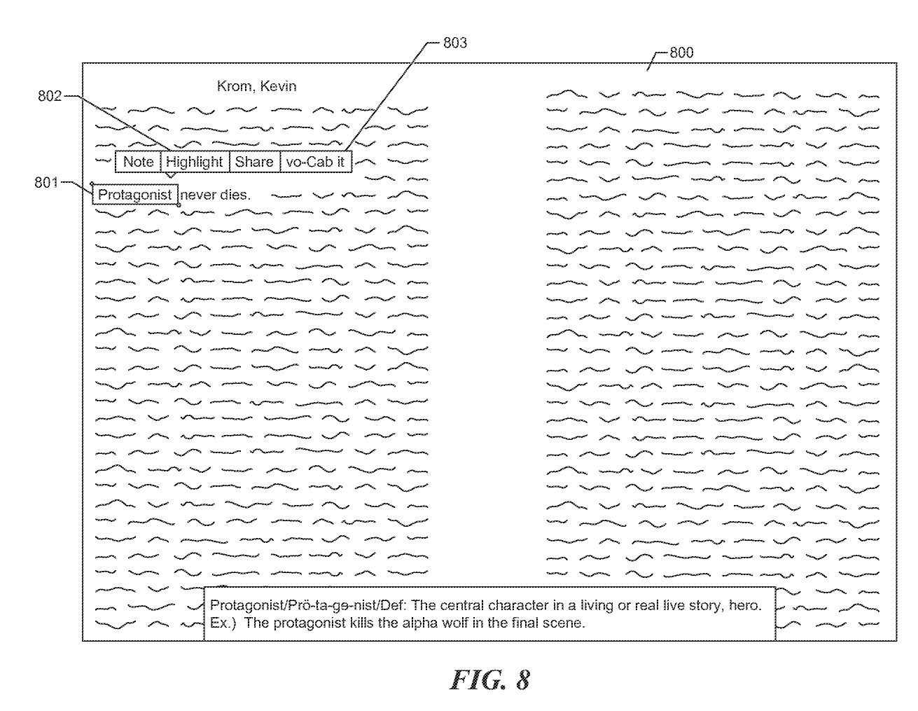

FIG. 8 shows a display presented by the facility when the user is working within an Ebook reader application, (Ibook, Kindle) on the controls of how to enter vocabulary words into the facility. The display 800 contains the controls for the online reading application: The display 801 contains a selected and highlighted word from within the reading application: The display 802 contains the normal reading application tabs note, highlight, and share: The display 803 contains controls for transferring vocabulary words into the facility.

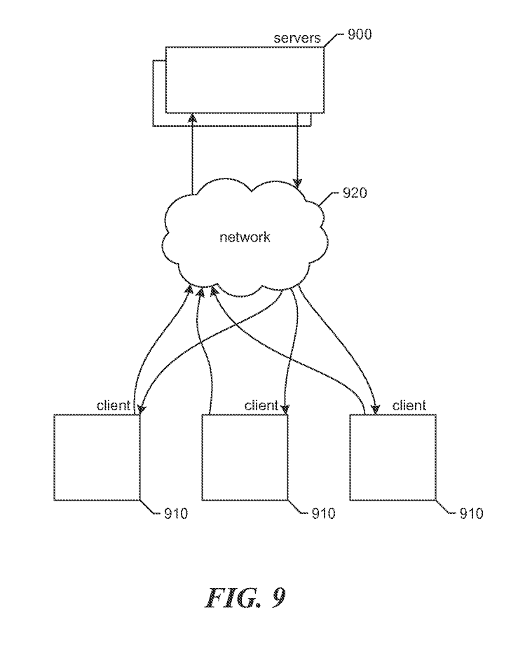

FIG. 9 is a network diagram of a sample arrangement of components used to provide a facility in some embodiments. The arrangement may comprise at least one client, e.g., a plurality of client computer systems 910 coupled to one or more servers 900 via a network 920, such as the Internet or an intranet. Client computer systems 910 may be under user control and may be used to select vocabulary cards, present vocabulary flash cards, administer vocabulary quizzes, display vocabulary learning results, etc.

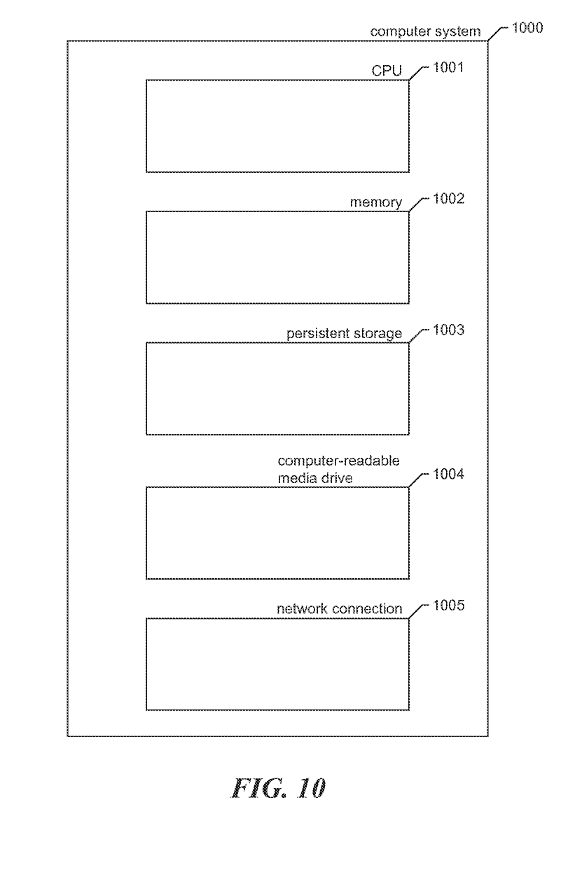

FIG. 10 is a block diagram showing some of the components typically incorporated in at least some of the computer systems and other devices on which the facility executes. In various embodiments, these computer systems and other devices 1000 can include server computer systems, desktop computer systems, laptop computer systems, tablets, netbooks, mobile phones, personal digital assistants, televisions, digital video recorders, set top boxes, cameras, automobile computers, electronic media players, etc. In various embodiments, these computer systems and devices 1000 may include one or more central processing units (“CPUs”) 1001 for executing computer programs; a computer memory 1002 for storing programs and data while they are being used, including the facility and associated data; a persistent storage device 1003, such as a hard drive for persistently storing programs and data; a computer-readable media drive 1004, such as a floppy, CD-ROM, DVD, or solid-state drive, for reading programs and data stored on a computer-readable medium; and a network connection 1005 for connecting the computer system to other computer systems, such as via the Internet or another data transmission network and its networking hardware, such as switches, routers, repeaters, electrical cables and optical fibers, light emitters and receivers, radio transmitters and receivers, and the like, so that data signals such as data signals conveying data structures, programs, and unstructured data may be sent between such computer systems. While computer systems configured as described above are typically used to support the operation of the facility, those skilled in the art will appreciate that the facility may be implemented using devices of various types and configurations, and having various components.

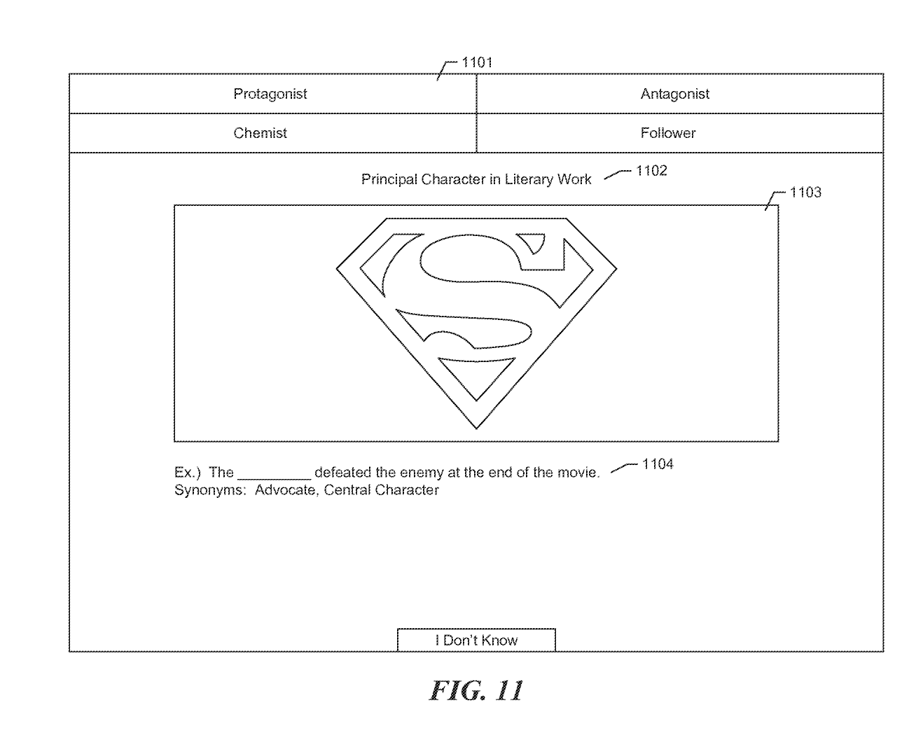

FIG. 11 shows a display presented by the facility as an alternative view for quizzing vocabulary words. The display 1101 contains four possible vocabulary words for the definition and the image. The display 1102 contains the definition for the vocabulary word in question. The display 1103 contains the image previously selected from a web based search (google image, bing image, etc). The display 1104 contains synonyms and antonyms for the vocabulary word in question.

We claim:

1. A method in a computer system, comprising:
determining that a user has selected a word in an arbitrary document; and
in response to the determining, causing to be displayed to the user a flashcard defining the selected word.

2. The method of claim 1, further comprising generating the flashcard in response to the determining.
